(19) United States
(12) Patent Application Publication
(10) Pub. No.: US 2009/0241621 A1
(43) Pub. Date: Oct. 1, 2009

(54) KEY ASSEMBLY

(75) Inventors: ZHENG SHI, Shenzhen City (CN); CHIH-CHIANG CHANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/141,235

(22) Filed: Jun. 18, 2008

(30) Foreign Application Priority Data
Mar. 26, 2008 (CN) 200810300709.8

(51) Int. Cl. E05B 19/00

(52) U.S. Cl. 70/395

(57) ABSTRACT

A key assembly (500) is configured in a housing (90) of an electronic device, the housing having an opening (902) defined therein. The key assembly includes an elastic key body (50) and a hollow carrier (52). The hollow carrier is received in the opening of the housing for holding the key body. The key body and the carrier together seal the opening.

### BACKGROUND OF THE INVENTION

1. Field of the Invention

The present invention concerns key assemblies for electronic devices.

2. Discussion of the Related Art

Portable electronic devices, such as mobile telephones and personal digital assistants (PDAs), are now in widespread use. These portable electronic devices enable consumers to enjoy high technology services, almost anytime and anywhere.

Keypads for data entry have become indispensable. Conventionally, keypads usually include a plurality of keys, such as numeral keys passing through holes in the separately made electronic device. Current manufacturing creates gaps between the keys and the housing. As a result, dust, water vapor and other impurities may enter the electronic device, weakening performance of the electronic device.

Therefore, people want a key assembly sealed against impurities such as dust and water.

### BRIEF DESCRIPTION OF THE DRAWINGS

FIG. 1 is an assembled view of a key assembly and a portion of an electronic device, according to an exemplary embodiment;

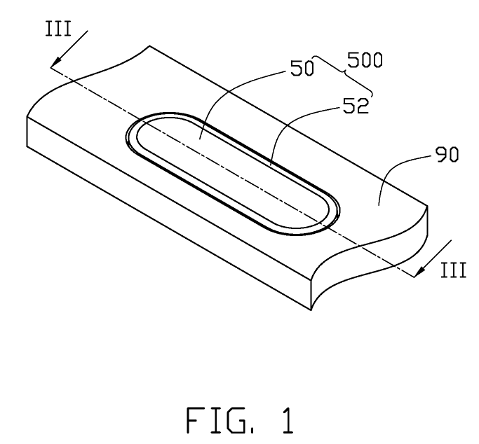

FIG. 2 is a disassembled view of the key assembly shown in FIG. 1; and

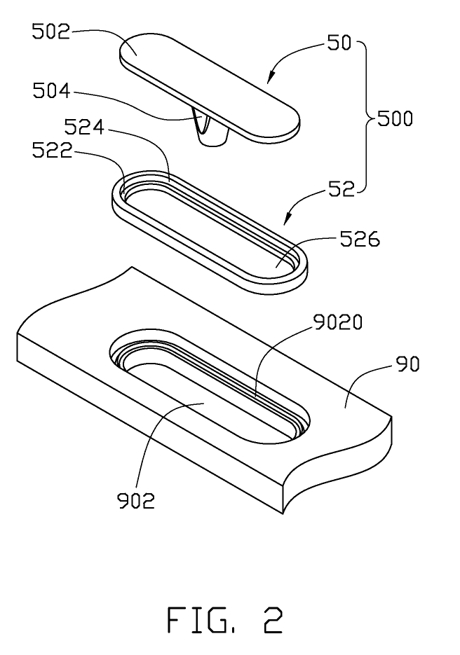

FIG. 3 is a cross-sectional view taken along line III-III of FIG. 1.

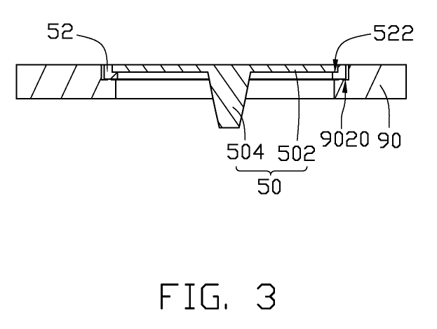

### DETAILED DESCRIPTION OF THE EMBODIMENTS

The present key assembly is suitable for portable electronic devices, such as a mobile phones, personal digital assistants (PDA), calculators, electronic dictionaries and so on. Therefore, the housing 90 shown in the FIGS. is generic to any such devices and includes a generic opening 902 with a mounting flange 9020. Generally, key assembly 500 installs in opening 902 as will now be described in greater detail.

The key assembly 500 includes a key body 50 and a carrier 52. The carrier 52 and the key body 50 can be two separate elements or a single element made by dual-material dual-injection molding.

Key body 50 is elastic, made from, for example, rubber. The key body 50 includes a pressing portion 502 integrally formed with a protruding portion 504. Protruding portion 504, which is optional, is for contacting the electronic element (not shown) of the electronic device when pressing the pressing portion 502. However, if omitting the protruding portion 504, the pressing portion 502 can directly contact the electronic element (not shown) of the electronic device when pressing the pressing portion 502.

Carrier 52 is a ring 522 installed in opening 902 and properly positioned in opening 902 by mounting flange 9020. Ring 522 defines a cavity 526 with an inwardly directed mounting wall 524. The pressing portion 502 is fixedly installed within cavity 526 with protruding portion 504 directed inwardly through cavity 526. Mounting wall 524 properly positions protruding portion 502 with cavity 526. By ultrasonically welding pressing portion 502 within cavity 526 seals the opening 902.

Ultrasonically welding the carrier 52 and the key body 50, tightly attaches carrier 52 and the housing 90. Therefore, dust, water vapor and other impurities are prevented from entering and degrading the quality and lifespan of the electronic device.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key assembly for a housing of an electronic device, the housing defining an opening, the key assembly comprising:
an elastic key body; and
a carrier for holding the key body, positioned in the housing opening for holding the key body, the key body and the carrier sealing the housing opening.

2. The key assembly as claimed in claim 1, wherein a flange protruding from an inner wall of the opening of the housing opening retains the carrier in the opening.

3. The key assembly as claimed in claim 2, wherein the carrier is a hollow ring for holding the key body therein.

4. The key assembly as claimed in claim 3, wherein carrier has a flange portion protruding form an inner wall for supporting and positioning the key body.

5. The key assembly as claimed in claim 2, wherein the key body includes a pressing portion and a protruding portion protruding from the pressing portion.

6. The key assembly as claimed in claim 1, wherein the key body and the protruding portion are formed as a single unit.

7. The key assembly as claimed in claim 1, wherein the carrier and the key body are formed by dual-material dual injection molding.

8. The key assembly as claimed in claim 1, wherein the carrier and the key body are fixed together by ultrasonic welding.
